(19) United States
(12) Patent Application Publication
(10) Pub. No.: US 2004/0168287 A1
(43) Pub. Date: Sep. 2, 2004

(54) Pressing apparatus for a semiconductor device

(76) Inventor: Chun-Tsai Yang, Kaohsiung City (TW)

Correspondence Address: LADAS & PARRY, 5670 WILSHIRE BOULEVARD, SUITE 2100, LOS ANGELES, CA, 90036-5679, US

(21) Appl. No.: 10/746,875

(22) Filed: Dec. 24, 2003

Related U.S. Application Data
(63) Continuation-in-part of application No. 10/180,001, filed on Jun. 24, 2002.

(30) Foreign Application Priority Data
Dec. 19, 2001 (TW) 090222628

(51) Int. Cl. B23P 23/04

(52) U.S. Cl. 29/33 R; 29/33 K

(57) ABSTRACT

In a pressing apparatus, a holding frame has a rear wall interconnecting and cooperating with opposite lateral walls so as to confine a receiving space for receiving a semiconductor device therein, and a bottom wall disposed at a bottom side of the receiving space. A positioning device, which is used to clamp the semiconductor device against the bottom wall, includes a press block unit disposed in the receiving space such that the semiconductor device is disposed between the press block unit and the bottom wall, two coupling blocks connected to opposite end portions of the press block unit, respectively, and two positioning pieces extending through screw holes in the coupling blocks, respectively, and operable to engage the lateral walls for retaining the press block unit at a desired position on the holding frame.

### CROSS-REFERENCE TO RELATED APPLICATION

This application is a continuation-in-part (CIP) of U.S. patent application Ser. No. 10/180,001, entitled “A PRESSING KIT FOR SUBSTRATE OR LEAD FRAME OF A SEMICONDUCTOR PACKING”, filed on Jun. 24, 2002.

### BACKGROUND OF THE INVENTION

1. Field of the Invention

The invention relates to a pressing apparatus, more particularly to a pressing apparatus for a semiconductor device.

2. Description of the Related Art

In a conventional packaging process for a semiconductor device, the semiconductor device, which includes a plurality of semiconductor chips adhered on a substrate or a lead frame by means of an adhesive, is encapsulated by a sealing resin and subsequently undergoes a curing process. However, in view of a difference between thermal expansion coefficients of the adhesive and the sealing resin, warpage of the semiconductor device is generally observed after curing.

FIG. 1 illustrates a semiconductor device 1 that exhibits warpage at corners of a substrate 11 after curing. Particularly, when a semiconductor chip of the semiconductor device 1 has a longer length or a larger size and when the substrate 11 is thinner, the coplanarity of the semiconductor device 1 is hardly maintained.

### SUMMARY OF THE INVENTION

Therefore, the object of the present invention is to provide a pressing apparatus for a semiconductor device that can effectively maintain the coplanarity of the semiconductor device after the latter is subjected to a curing process.

According to the present invention, there is provided a pressing apparatus for a semiconductor device. The pressing apparatus comprises:

a holding frame having opposite lateral walls spaced apart from each other in a transverse direction, each of the lateral walls having opposite front and rear ends, the holding frame further having a rear wall interconnecting the rear ends of the lateral walls, the lateral walls cooperating with the rear wall so as to confine a receiving space having top and bottom sides, the holding frame further having a bottom wall disposed at the bottom side, the receiving space being adapted for receiving the semiconductor device therein; and

a positioning device including

an elongate press block unit disposed in the receiving space such that the semiconductor device is disposed between the press block unit and the bottom wall, the press block unit having opposite end portions that are opposite to each other in the transverse direction,

a pair of L-shaped coupling blocks, each of which has a first portion connected to a corresponding one of the end portions of the press block unit, and a second portion connected to the first portion and cooperating with the corresponding one of the end portions of the press block unit so as to confine a mounting groove for extension of a corresponding one of the lateral walls therethrough, the second portion of each of the coupling blocks being formed with a screw hole, and

a pair of positioning pieces, each of which has an operating end portion disposed on the second portion of a corresponding one of the coupling blocks, a screw rod connected to the operating end portion and extending through the screw hole in the second portion of the corresponding one of the coupling blocks, and an abutting end portion connected to the screw rod and disposed between a corresponding one of the lateral walls and the second portion of the corresponding one of the coupling blocks.

The press block unit is movable to clamp the semiconductor device against the bottom wall. The positioning pieces are operable to engage the lateral walls for retaining the press block unit at a desired position on the holding frame.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a semiconductor device that exhibits warpage after undergoing a curing process;

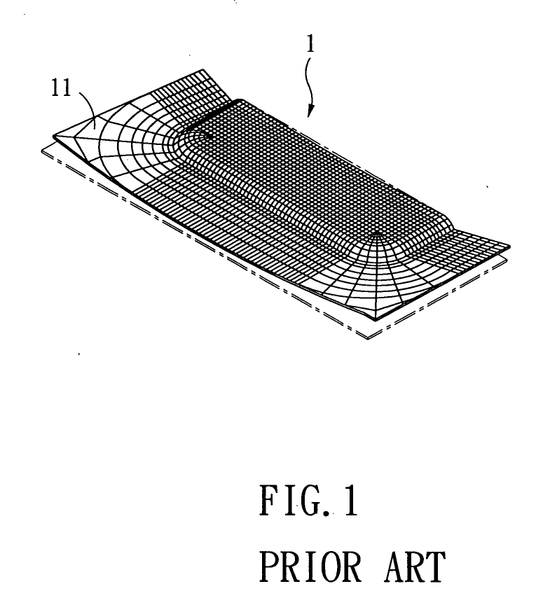

FIG. 2 is an exploded perspective view showing the preferred embodiment of a pressing apparatus for a semiconductor device according to the present invention;

FIG. 3 is an assembled perspective view of the preferred embodiment;

FIG. 4 is a fragmentary schematic sectional view showing a press block unit of a positioning device of the preferred embodiment;

FIG. 5 is an exploded schematic front view showing the preferred embodiment when a stack of semiconductor devices are disposed in a holding frame;

FIG. 6 is a schematic, partly sectional, front view showing the preferred embodiment when the positioning device is in a loosely clamped state;

FIG. 7 is a schematic, partly sectional, front view showing the preferred embodiment when the positioning device is in a tightly clamped state; and

FIG. 8 is a schematic front view showing the stack of semiconductor devices being subjected to a curing process while clamped by the preferred embodiment.

### DETAILED DESCRIPTION OF THE PREFERRED EMBODIMENT

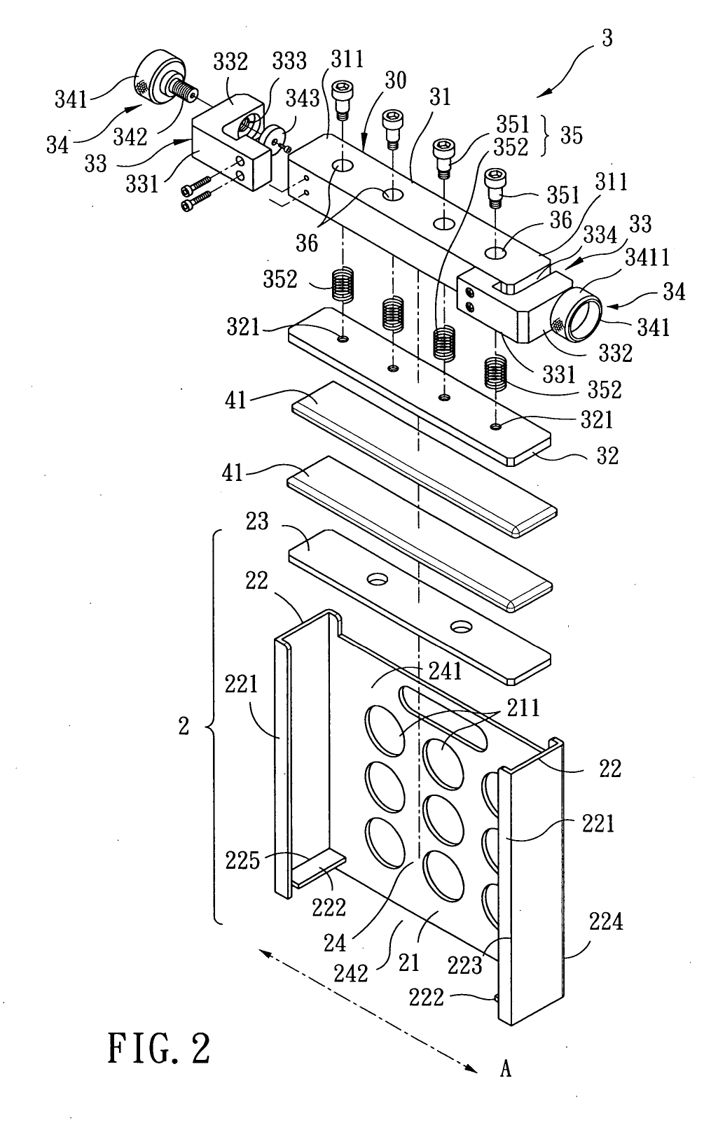

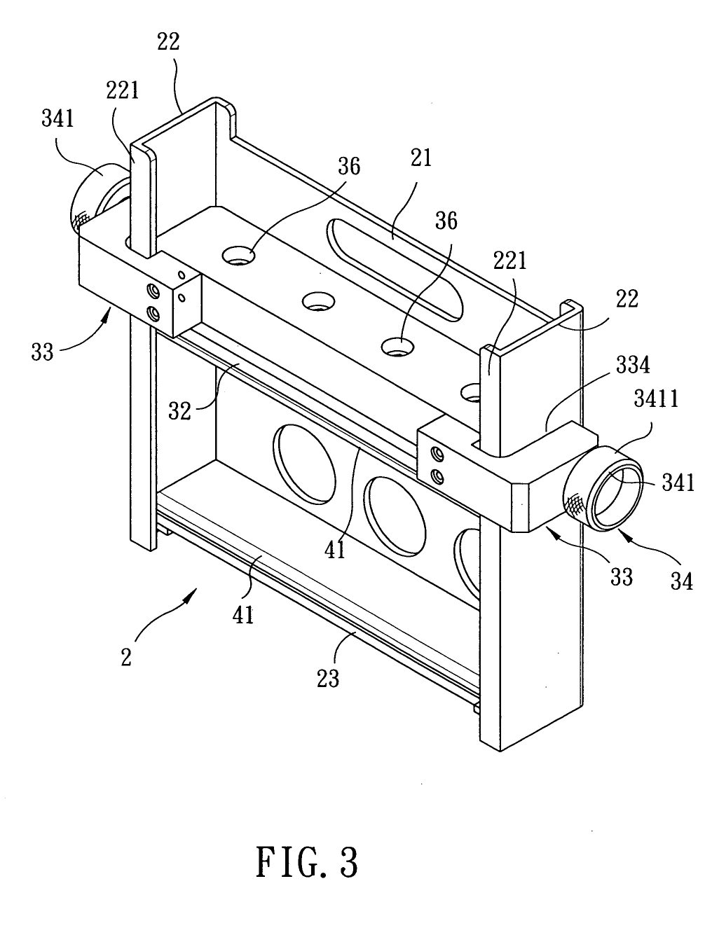

Referring to FIGS. 2, 3 and 5, the preferred embodiment of a pressing apparatus for a stack of semiconductor devices 5 according to the present invention is shown to include a holding frame 2 and a positioning device 3.

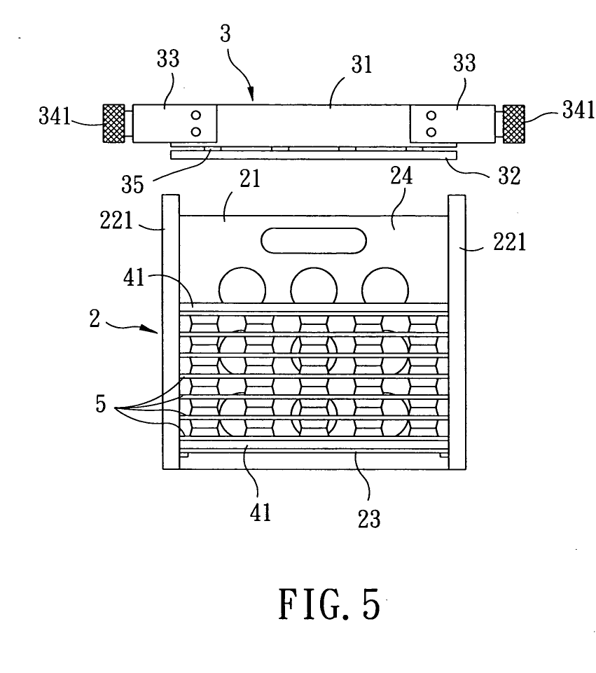

The holding frame 2 has opposite lateral walls 22 spaced apart from each other in a transverse direction (A). Each of the lateral walls 22 has opposite front and rear ends 223, 224. A rear wall 21 interconnects the rear ends 224 of the lateral walls 22. The lateral walls 22 cooperate with the rear wall 21 so as to confine a receiving space 24 having top and bottom sides 241, 242. The holding frame 2 further has a bottom wall 23 disposed at the bottom side 242. The receiving space 24 is adapted for receiving the semiconductor devices 5 therein, as best shown in FIG. 5. Each lateral wall 22 is formed with a stop flange 221 that extends inwardly from the front end 223 in the transverse direction (A), and has a bottom end 225 formed with an inward flange 222 such that the bottom wall 23 is supported removably in the receiving space 24 by the inward flanges 222 on the lateral walls 22. The rear wall 21 is preferably formed with a plurality of vent holes 211.

The positioning device 3 includes an elongate press block unit 30, a pair of L-shaped coupling blocks 33, and a pair of positioning pieces 34.

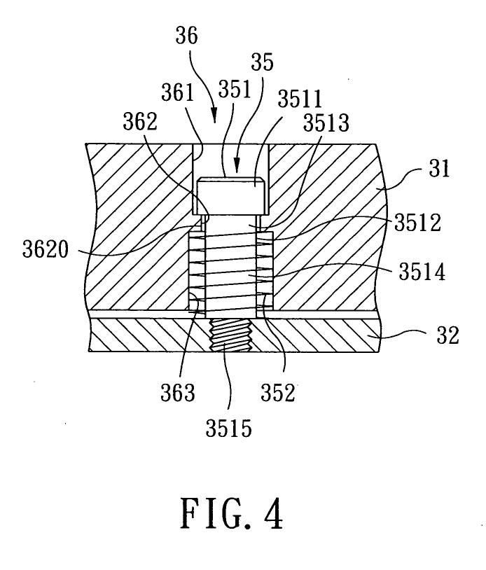

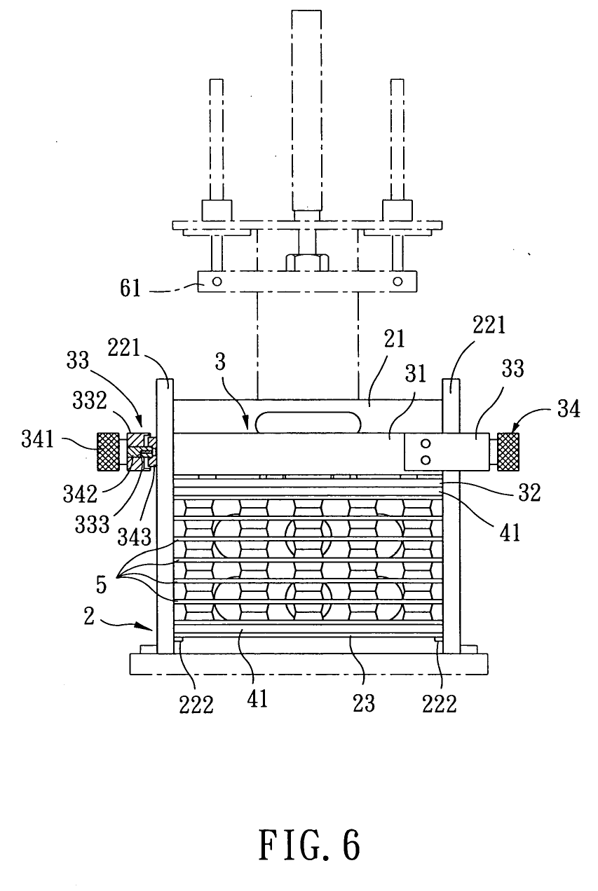

The press block unit 30 is disposed in the receiving space 24 such that the semiconductor devices 5 are disposed between the press block unit 30 and the bottom wall 23, as best shown in FIG. 6. In this embodiment, the press block unit 30 includes a press plate 32 disposed in the receiving space 24, a mounting block 31 disposed above the press plate 32 in the receiving space 24 and having opposite end portions 311 that are opposite to each other in the transverse direction (A), and a set of spring-loaded fasteners 35 that interconnect the press plate 32 and the mounting block 31. The mounting block 31 is formed with a set of mounting holes 36. Each fastener 35 extends through a corresponding one of the mounting holes 36 and engages the press plate 32. Referring to FIG. 4, each mounting hole 36 has an upper portion 361, a lower portion 363, and a restricted intermediate portion 362 between the upper portion 361 and the lower portion 363. The restricted intermediate portion 362 is confined by an annular shoulder 3620. Each fastener 35 includes a screw head 3511 received in the upper portion 361 of the corresponding one of the mounting holes 36, and a screw shaft 3512 that has a connecting end portion 3513 connected to the screw head 3511 and disposed in the restricted intermediate portion 362 of the corresponding one of the mounting holes 36, an intermediate shaft portion 3514 connected to the connecting end portion 3513 and received in the lower portion 363 of the corresponding one of the mounting holes 36, and a threaded end portion 3515 opposite to the connecting end portion 3513, connected to the intermediate shaft portion 3514, and threadedly engaging the press plate 32. Each fastener 35 further includes a coil spring 352 disposed in the lower portion 363 of the corresponding one of the mounting holes 36, surrounding the intermediate shaft portion 3514 of the screw shaft 3512, and having opposite ends abutting respectively against the annular shoulder 3620 of the corresponding one of the mounting holes 36 and the press plate 32.

Each coupling block 33 has a first portion 331 connected to a corresponding one of the end portions 311 of the mounting block 31 of the press block unit 30, and a second portion 332 connected to the first portion 331 and cooperating with the corresponding one of the end portions 311 of the mounting block 31 so as to confine a mounting groove 334 for extension a corresponding one of the lateral walls 22 therethrough, as shown in FIG. 2. The second portion 332 of each of the coupling blocks 33 is formed with a screw hole 333 in the transverse direction (A).

Each positioning piece 34 has an operating end portion 341 disposed on the second portion 332 of a corresponding one of the coupling blocks 33, a screw rod 342 connected to the operating end portion 341 and extending through the screw hole 333 in the second portion 332 of the corresponding one of the coupling blocks 33, and an abutting end portion 343 connected to the screw rod 333 and disposed between a corresponding one of the lateral walls 22 and the second portion 332 of the corresponding one of the coupling blocks 33. In this embodiment, the operating end portion 341 of each positioning piece 34 has a knurled outer surface 3411 so as to facilitate handling of the same.

The pressing apparatus 3 further includes two buffer plates 41 disposed in the receiving space 24, one of which is arranged between the semiconductor devices 5 and the press plate 32, and the other one of which is arranged between the semiconductor devices 5 and the bottom wall 23. In this embodiment, the buffer plates 41 are made from heat-resistant material.

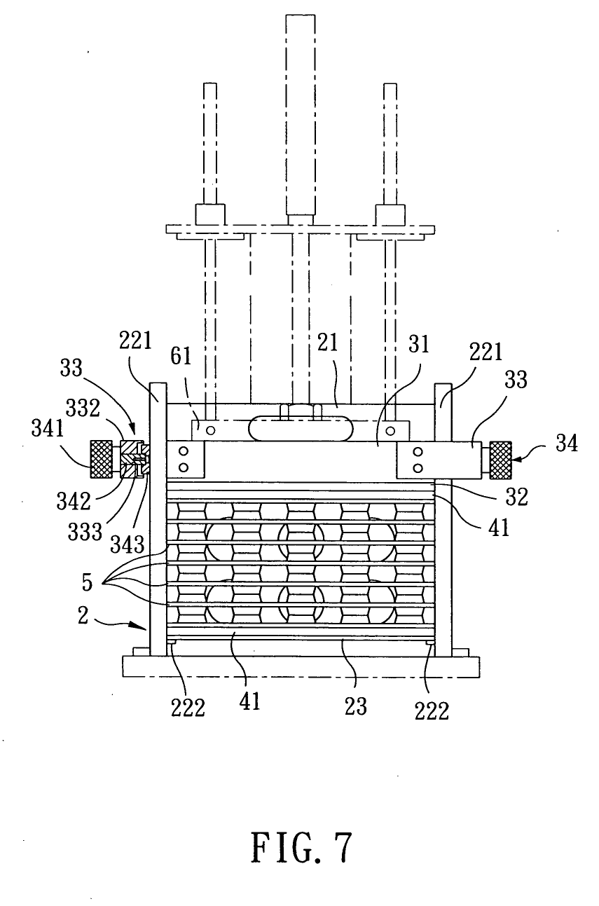

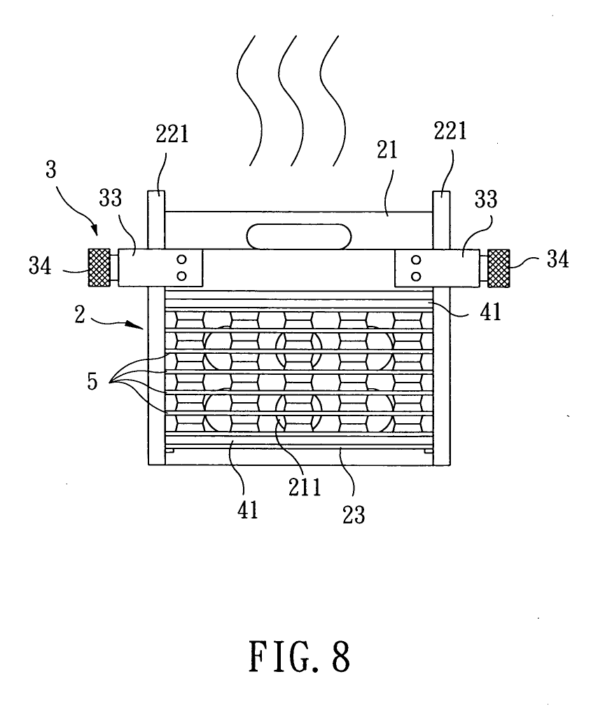

In use, referring further to FIGS. 5 to 8, the positioning device 3 is initially detached from the holding frame 2, and the semiconductor devices 5 to be subjected to the curing process are disposed in the receiving space 24 and between the buffer plates 41, as shown in FIG. 5. Subsequently, the positioning device 3 is mounted slidably on the lateral walls 22 such that the press plate 32 abuts against an upper one of the buffer plates 41, as shown in FIG. 6. Finally, the press block unit 30 is pressed downwardly by a pressing member 61 (shown in imaginary lines) so as to clamp the semiconductor devices 5 tightly against the bottom wall 23, and the positioning pieces 34 are subsequently operated to engage the lateral walls 22 for retaining the press block unit 30 at a desired position on the holding frame 2, as shown in FIG. 7. It is noted that, due to the buffer effect of the coil springs 352, damage to the semiconductor devices 5 can be avoided when the press block unit 30 is pressed by the pressing member 61. Thereafter, the semiconductor devices 5, while clamped by the pressing apparatus, are subjected to the curing process as best shown in FIG. 8.

Since the semiconductor devices 5 are clamped by the pressing apparatus of this invention during curing, warpage of the semiconductor devices 5 can be avoided such that the coplanarity of the semiconductor devices 5 can be effectively maintained.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A pressing apparatus for a semiconductor device, comprising:
a holding frame having opposite lateral walls spaced apart from each other in a transverse direction, each of said lateral walls having opposite front and rear ends, said holding frame further having a rear wall interconnecting said rear ends of said lateral walls, said lateral walls cooperating with said rear wall so as to confine a receiving space having top and bottom sides, said holding frame further having a bottom wall disposed at said bottom side, said receiving space being adapted for receiving the semiconductor device therein; and
a positioning device including
an elongate press block unit disposed in said receiving space such that the semiconductor device is disposed between said press block unit and said bottom wall, said press block unit having opposite end portions that are opposite to each other in the transverse direction,
a pair of L-shaped coupling blocks, each of which has a first portion connected to a corresponding one of said end portions of said press block unit, and a second portion connected to said first portion and cooperating with the corresponding one of said end portions of said press block unit so as to confine a mounting groove for extension of a corresponding one of said lateral walls therethrough, said second portion of each of said coupling blocks being formed with a screw hole, and
a pair of positioning pieces, each of which has an operating end portion disposed on said second portion of a corresponding one of said coupling blocks, a screw rod connected to said operating end portion and extending through said screw hole in said second portion of the corresponding one of said coupling blocks, and an abutting end portion connected to said screw rod and disposed between a corresponding one of said lateral walls and said second portion of the corresponding one of said coupling blocks;
said press block unit being movable to clamp the semiconductor device against said bottom wall, said positioning pieces being operable to engage said lateral walls for retaining said press block unit at a desired position on said holding frame.

2. The pressing apparatus as claimed in claim 1, wherein each of said lateral walls is formed with a stop flange that extends inwardly from said front end in the transverse direction.

3. The pressing apparatus as claimed in claim 1, further comprising a set of buffer plates disposed in said receiving space and distributed among said press block unit, said bottom wall and the semiconductor device.

4. The pressing apparatus as claimed in claim 3, wherein said buffer plates are made from heat-resistant metal.

5. The pressing apparatus as claimed in claim 1, wherein said rear wall is formed with a plurality of vent holes.

6. The pressing apparatus as claimed in claim 1, wherein each of said lateral walls has a bottom end formed with an inward flange, said bottom wall being supported removably in said receiving space by said inward flanges on said lateral walls.

7. The pressing apparatus as claimed in claim 1, wherein said press block unit of said positioning device includes
a press plate disposed in said receiving space,
a mounting block disposed above said press plate in said receiving space and formed with said end portions, and
a set of spring-loaded fasteners that interconnect said press plate and said mounting block.

8. The pressing apparatus as claimed in claim 7, wherein said mounting block is formed with a set of mounting holes, each of said fasteners extending through a corresponding one of said mounting holes and engaging said press plate.

9. The pressing apparatus as claimed in claim 8, wherein each of said mounting holes has an upper portion, a lower portion, and a restricted intermediate portion between said upper portion and said lower portion, said restricted intermediate portion being confined by an annular shoulder,
each of said fasteners including a screw head received in said upper portion of the corresponding one of said mounting holes, and a screw shaft that has a connecting end portion connected to said screw head and disposed in said restricted intermediate portion of the corresponding one of said mounting holes, an intermediate shaft portion connected to said connecting end portion and received in said lower portion of the corresponding one of said mounting holes, and a threaded end portion opposite to said connecting end portion, connected to said intermediate shaft portion, and threadedly engaging said press plate,
each of said fasteners further including a coil spring disposed in said lower portion of the corresponding one of said mounting holes, surrounding said intermediate shaft portion of said screw shaft, and having opposite ends abutting respectively against said annular shoulder of the corresponding one of said mounting holes and said press plate.
